(19) United States
(12) Patent Application Publication
(10) Pub. No.: US 2023/0130722 A1
(43) Pub. Date: Apr. 27, 2023

(54) CARD EDGE CONNECTOR AND CIRCUIT BOARD

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Pengfei LANG, Mie (JP); Tetsuya MIYAMURA, Mie (JP); Daisuke SAITO, Mie (JP); Yutaka KOBAYASHI, Mie (JP)

(21) Appl. No.: 17/911,850

(22) PCT Filed: Mar. 5, 2021
(86) PCT No.: PCT/JP2021/008735

§ 371 Date: Sep. 15, 2022

(30) Foreign Application Priority Data
Mar. 26, 2020 (JP) 2020-055506

(51) Int. Cl. H01R 12/72; H01R 13/40; H01R 12/57; H01R 13/639; H01R 13/24

(52) U.S. Cl. CPC H01R 12/721; H01R 13/40; H01R 12/57; H01R 13/639; H01R 13/2407

(57) ABSTRACT

It is aimed to stabilize a contact pressure. A card edge connector (A) is provided with a female housing (30), terminal fittings (40) mounted in the female housing (40), and a circuit board (12) having mounting surfaces (13) and to be fit into the female housing (40) in parallel to the mounting surfaces (13). The circuit board (12) is provided with board-side terminals (20) projecting from the mounting surfaces (13). The terminal fitting (40) is formed with a recess (43) for accommodating the board-side terminal (20). A resilient contact piece (44) provided in the recess (43) resiliently contacts the board-side terminal (20).

### TECHNICAL FIELD

The present disclosure relates to a card edge connector and a circuit board.

### BACKGROUND

Patent Document 1 discloses an electrical connector in which a circuit board is inserted into a connector housing having connector terminals mounted therein and resilient contact pieces of the terminal fittings are brought into contact with both front and back surfaces of the circuit board.

### PRIOR ART DOCUMENT

### Patent Document

Patent Document 1: JP 2013-171690 A

### SUMMARY OF THE INVENTION

### Problems to be Solved

In the above electrical connector, when the resilient contact pieces resiliently come into contact with the circuit board, the connector housing receives a reaction force acting on the connector terminals from the circuit board. Since the connector housing is made of synthetic resin, a thermal contraction amount and a thermal expansion amount are relatively large. Thus, contact pressures of the resilient contact pieces with the circuit board are not stable. Further, the resilient contact pieces of the terminal fittings come into contact with the front and back surfaces of the circuit board in a plate thickness direction of the circuit board. Therefore, if a thickness of the circuit board varies, the contact pressures of the resilient contact pieces with the circuit board are not stable.

As a form different from the above electrical connector, it is considered to mount a plurality of terminal portions on mounting surfaces of a circuit board and resiliently bring resilient contact pieces of terminal fittings into contact with the respective terminal portions. In this case, if the plurality of terminal portions are individually mounted on the mounting surfaces, many terminal portion mounting steps are performed for the circuit board and manufacturing cost increases.

A card edge connector of a first aspect of the present disclosure was completed on the basis of the above situation and aims to stabilize a contact pressure. A circuit board of a second aspect of the present disclosure was completed on the basis of the above situation and aims to reduce manufacturing cost.

### Means to Solve the Problem

The first aspect of the present disclosure is directed to a card edge connector with a housing, a terminal fitting mounted in the housing, and a circuit board having a mounting surface, the circuit board being fit into the housing in parallel to the mounting surface, wherein the circuit board is provided with a board-side terminal projecting from the mounting surface, the terminal fitting is formed with a recess for accommodating the board-side terminal, and a resilient contact piece provided in the recess resiliently contacts the board-side terminal.

The second aspect of the present disclosure is directed to a circuit board with a mounting surface and a plurality of board-side terminals projecting from the mounting surface, wherein terminal fittings mounted in a housing are in contact with the board-side terminals with the circuit board fit in the housing in parallel to the mounting surface, a single mounting member including a plurality of supporting portions is mounted on the mounting surface, and the plurality of board-side terminals are individually mounted on the plurality of supporting portions.

### Effect of the Invention

According to the first aspect of the present disclosure, a contact pressure can be stabilized. According to the second aspect of the present disclosure, manufacturing cost can be reduced.

### BRIEF DESCRIPTION OF THE DRAWINGS

FIG. 1 is an exploded perspective view of a male connector constituting a card edge connector of a first embodiment.

FIG. 2 is an exploded perspective view of a female connector constituting the card edge connector.

FIG. 3 is an exploded perspective view of a terminal module to be mounted on a circuit board.

FIG. 4 is a section of the circuit board.

FIG. 5 is a section along X-X of FIG. 4.

FIG. 6 is a side view showing a state where terminal fittings are mounted in a housing of the female connector.

FIG. 7 is a side view in section showing the state where the terminal fittings are mounted in the housing of the female connector.

FIG. 8 is a side view showing a state where first housings and the terminal fittings are displaced to non-contact positions.

FIG. 9 is a side view in section showing the state where the first housings and the terminal fittings are displaced to the non-contact positions.

FIG. 10 is a side view showing a state where the terminal fittings are displaced to contact positions and connected to board-side terminals.

FIG. 11 is a side view in section showing the state where the terminal fittings are displaced to the contact positions and connected to the board-side terminals.

FIG. 12 is a perspective view showing a state where a second housing and a third housing are assembled in a second embodiment.

FIG. 13 is a perspective view showing a state where the second housing and the third housing are separated.

FIG. 14 is a perspective view of a circuit board.

FIG. 15 is a plan view in section showing a state where a resilient locking piece of the second housing is locked to the circuit board.

FIG. 16 is a plan view in section showing a state where a second resilient locking piece of the second housing and a third resilient locking piece of the third housing are locked to the circuit board.

### DETAILED DESCRIPTION TO EXECUTE THE INVENTION

### Description of Embodiments of Present Disclosure

First, embodiments of the present disclosure are listed and described.

(1) The card edge connector of the first aspect of the present disclosure is provided with a housing, a terminal fitting mounted in the housing, and a circuit board having a mounting surface, the circuit board being fit into the housing in parallel to the mounting surface, wherein the circuit board is provided with a board-side terminal projecting from the mounting surface, the terminal fitting is formed with a recess for accommodating the board-side terminal, and a resilient contact piece provided in the recess resiliently contacts the board-side terminal. According to the configuration of the present disclosure, a reaction force from the board-side terminal is received by the terminal fitting when the resilient contact piece resiliently contacts the board-side terminal. Even if the housing is thermally deformed or a plate thickness of the circuit board varies, a contact pressure between the terminal fitting and the board-side terminal is stabilized.

(2) Preferably, the terminal fitting is supported to be swingable between a connection position near the mounting surface and a non-connection position separated from the mounting surface with a shaft portion as a fulcrum, the resilient contact piece is in contact with the board-side terminal with the terminal fitting located at the connection position, and the resilient contact piece is not in contact with the board-side terminal with the terminal fitting located at the non-connection position. To fit the recess of the terminal fitting to and bring the resilient contact piece into contact with the board-side terminal projecting from the mounting surface of the circuit board, the terminal fitting needs to be displaced in directions toward and away from the mounting surface. If the terminal fitting is parallelly moved in a direction orthogonal to the mounting surface, a structure for guiding the terminal fitting becomes complicated. Since the terminal fitting is swung in the present disclosure, the structure for guiding the terminal fitting can be simplified.

(3) Preferably, in (2), the housing includes a first housing for holding the terminal fitting, a second housing including a stopper, an inserting end part of the circuit board butting against the stopper, the second housing holding the first housing such that the first housing is swingable between the connection position and the non-connection position with the shaft portion as the fulcrum, and a third housing relatively displaceable in parallel to a fitting direction of the housing and the circuit board with respect to the second housing, the first and second housings are restricted from being relatively displaced in a direction parallel to the fitting direction of the housing and the circuit board, and the third housing is formed with a guide portion for displacing the first housing between the connection position and the non-connection position as the second and third housings are relatively displaced.

To displace the terminal fitting from the non-connection position to the connection position and bring the terminal fitting into contact with the board-side terminal, it is considered to swing the terminal fitting from the non-connection position to the connection position while the circuit board is inserted into the housing. However, since the circuit board and the terminal fitting are relatively displaced in two different directions in this case, a relative displacement path of the resilient contact piece with respect to the board-side terminal becomes unstable and the resilient contact piece may interfere with the board-side terminal. In the present disclosure, the terminal fitting is swung using the shaft portion as the fulcrum with the circuit board butted against the stopper of the second housing. Since the shaft portion is not relatively displaced in a front-rear direction with respect to the stopper, the relative displacement path of the resilient contact piece with respect to the board-side terminal is stabilized. In this way, the resilient contact piece and the board-side terminal can be connected without interfering with each other.

(4) Preferably, in (3), the second housing is formed with a resilient holding piece for holding the first housing in a state assembled with the second housing by being resiliently deformed in the process of assembling the first housing with the second housing. According to this configuration, the first housing is easily assembled with the second housing.

(5) Preferably, in (4), the second housing is formed with a guide groove along a swing path of the first housing, the first housing is formed with a guide pin and the shaft portion, the guide pin is slidable in contact with the guide groove from behind, and the shaft portion is locked to the resilient holding piece from front. According to this configuration, the first housing can be positioned in the front-rear direction and held with respect to the second housing even without forming a circular bearing hole in the second housing.

(6) Preferably, in (3) to (5), the circuit board is formed with a second locking portion and a third locking portion, the second locking portion is resiliently locked to a second resilient locking piece of the second housing with the circuit board butted against the stopper, and the third locking portion resiliently locks a third resilient locking piece of the third housing with the first housing displaced to the connection position. In a state where both the second and third housings are not locked to the circuit board, the second and third housings individually rattle with respect to the circuit board. According to the present disclosure, since the second third housings are individually and resiliently locked to the circuit board, the rattling of the second housing with respect to the circuit board and the rattling of the third housing with respect to the circuit board can be prevented.

(7) Preferably, in (1) to (6), a plurality of the board-side terminals are arranged side by side in a row, and the recess penetrates in the same direction as an arrangement direction of the board-side terminals. According to this configuration, position shifts of the board-side terminals and the terminal fittings in the arrangement direction of the board-side terminals can be absorbed.

(8) Preferably, in (1) to (7), a wire is connected to a rear end part of the terminal fitting, and the resilient contact piece is arranged along an inner surface on a front side of the recess. According to this configuration, when the wire is pulled rearward, the resilient contact piece is resiliently deformed, thereby reducing a load to the board-side terminal.

(9) Preferably, in (1) to (8), a contact point portion of the resilient contact piece is arranged in a region closer to the mounting surface than a center of the resilient contact piece in a projecting direction of the board-side terminal. According to this configuration, a contact position of the board-side terminal and the contact point portion of the resilient contact piece is near the mounting surface. Thus, a projection dimension of the board-side terminal from the mounting surface can be reduced.

(10) The circuit board of the second aspect of the present disclosure is provided with a mounting surface and a plurality of board-side terminals projecting from the mounting surface, wherein terminal fittings mounted in a housing are in contact with the board-side terminals with the circuit board fit in the housing in parallel to the mounting surface, a single mounting member including a plurality of supporting portions is mounted on the mounting surface, and the plurality of board-side terminals are individually mounted on the plurality of supporting portions. In the case of individually mounting the plurality of board-side terminals on the circuit board, many mounting steps are performed for the circuit board. According to the present disclosure, the mounting member may be mounted on the mounting surface after the plurality of board-side terminals are mounted on the plurality of supporting portions. Thus, the mounting member can be mounted on the mounting surface with one action. Therefore, the manufacturing cost of the circuit board can be reduced.

(11) Preferably, in (10), the supporting portion is formed with a retaining portion for preventing separation of the board-side terminal by locking the board-side terminal, and a clearance in a direction parallel to a projecting direction of the board-side terminal from the mounting surface is secured between the board-side terminal and the retaining portion. If the board-side terminals are fixedly mounted on the supporting portions, mounted positions of the board-side terminals on the supporting portions possibly vary due to dimensional tolerances of the supporting portions and the board-side terminals. If the mounted positions of the board-side terminals on the supporting portions vary, there is a concern that the board-side terminals are not in contact with the mounting surface. According to the present disclosure, since the clearance is provided in the projecting direction of the board-side terminal from the mounting surface between the retaining portion of the supporting portion and the board-side terminal, the board-side terminal can be reliably brought into contact with the mounting surface by its own weight if the mounting surface is horizontally arranged.

(12) Preferably, in (10) or (11), the board-side terminal includes a board contact portion to be fixed to the mounting surface by solder and a terminal contact portion located on a side opposite to the mounting surface across the board contact portion, a resilient contact piece of the terminal fitting being brought into contact with the terminal contact portion, and the board contact portion is formed with a seating surface portion parallel to the mounting surface of the circuit board and projecting toward a contact surface with the terminal fitting in the terminal contact portion. According to this configuration, a close contact region of the solder with the board contact portion is within the thickness of the seating surface portion. Therefore, there is no possibility that the solder spreads up to the contact surface with the terminal fitting in the terminal contact portion.

(13) Preferably, in (10) to (12), the board-side terminal is formed with a curved surface portion along a displacement path of the terminal fitting swinging with a shaft portion as a fulcrum, and a resilient contact piece of the terminal fitting slides in contact with the curved surface portion while being resiliently deformed. According to this configuration, since a resilient displacement amount of the resilient contact piece with respect to the board-side terminal is stabilized in the process of swinging the terminal fitting, resistance in swinging the terminal fitting is stabilized.

### Details of Embodiments of Present Disclosure

### First Embodiment

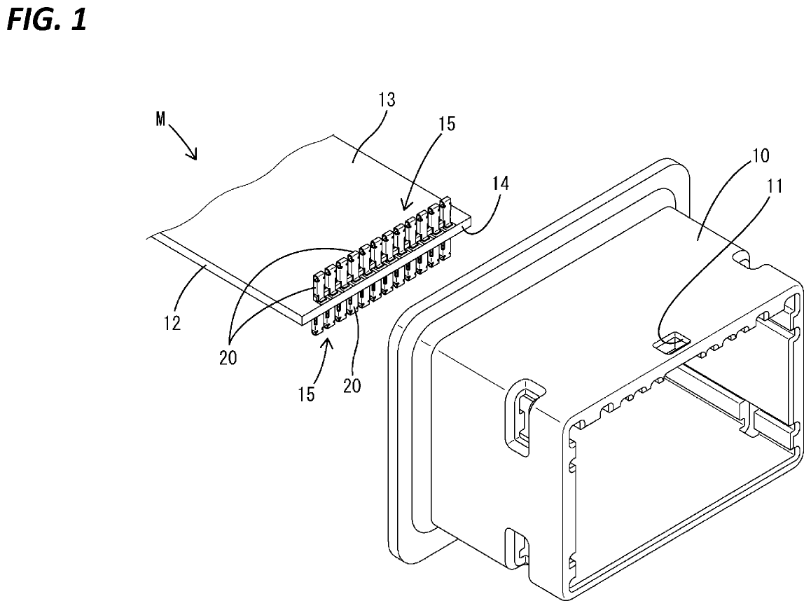

A specific first embodiment of a card edge connector A of the present disclosure is described below with reference to FIGS. 1 to 11. Note that the present invention is not limited to these illustrations and is intended to be represented by claims and include all changes in the scope of claims and in the meaning and scope of equivalents.

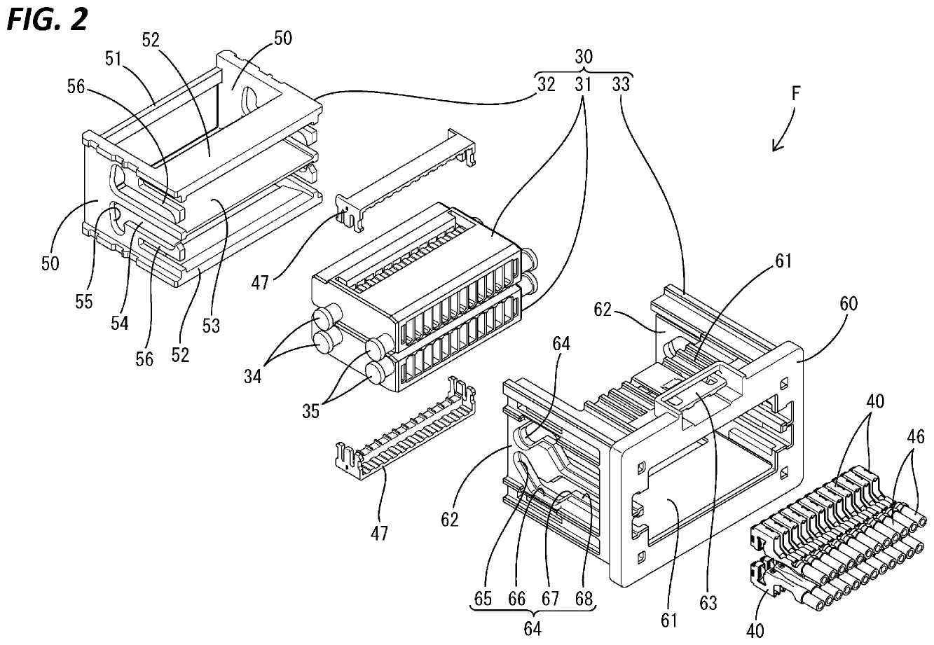

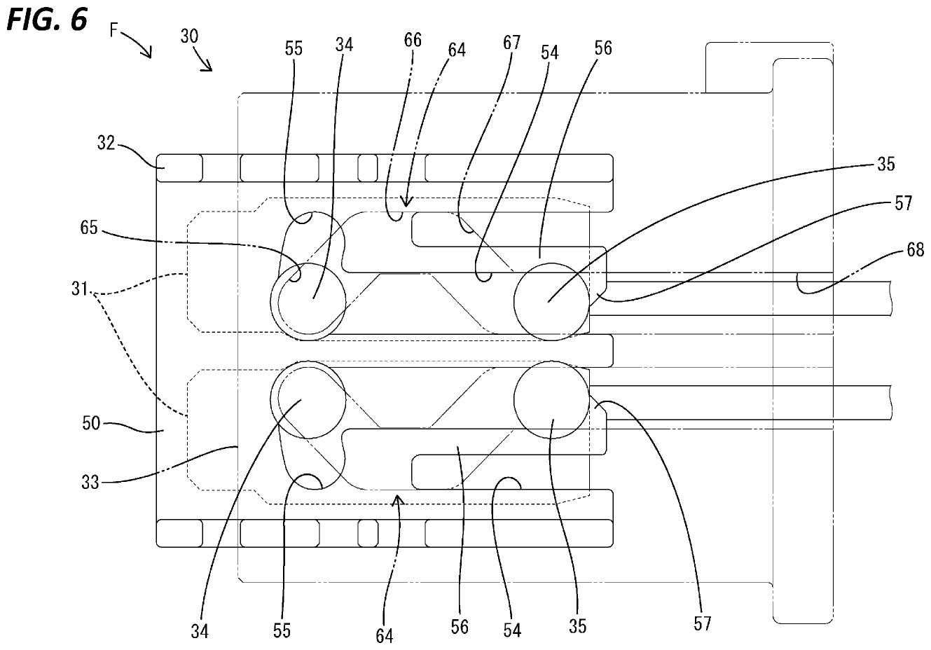

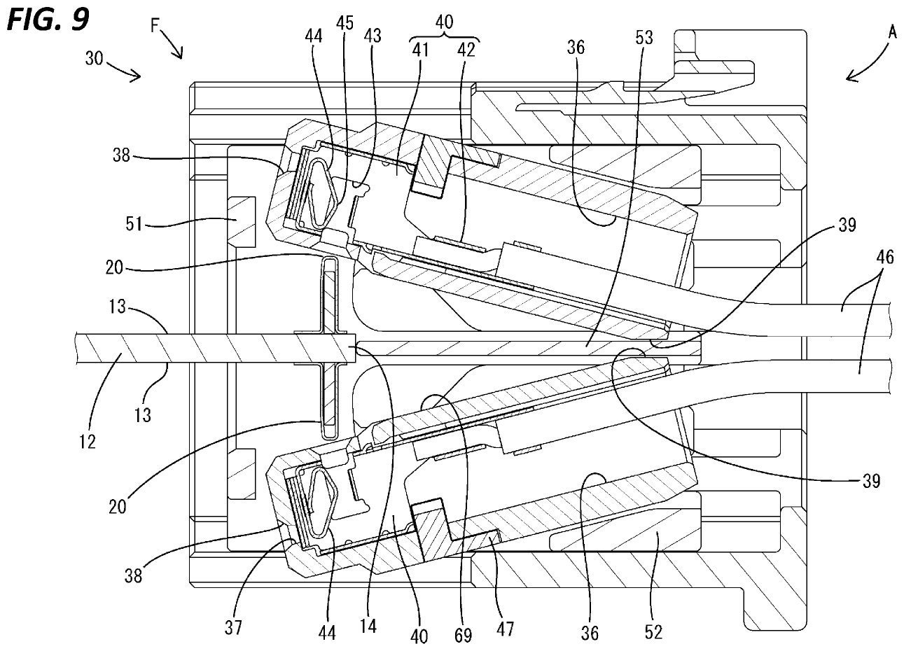

The card edge connector A of the first embodiment includes a male connector M and a female connector F. The male and female connectors M, F are connected by being brought closer in a front-rear direction while facing each other. In the first embodiment, an oblique right lower side in FIG. 1 and a right side in FIGS. 9 to 11 are defined as a front side concerning a front-rear direction of the male connector M. An oblique left upper side in FIG. 2 and a left side in FIGS. 6 to 11 are defined as a front side concerning a front-rear direction of the female connector F. The front-rear directions and a connecting direction of the male connector M (circuit board 12) and the female connector F are used as synonyms. Upper and lower sides shown in FIGS. 1 to 11 are directly defined as upper and lower sides concerning a vertical direction.

The male connector M is configured by assembling the circuit board 12 with a receptacle-like male housing 10. The male housing 10 is formed with a lock hole 11. The front surface (upper surface in FIGS. 1 and 3 to 5) and the back surface (lower surface in FIGS. 1 and 3 to 5) of the circuit board 12 serve as mounting surfaces 13 formed with printed circuits (not shown). An end edge part to be fit into the female connector F, out of an outer peripheral edge part of the circuit board 12, serves as an inserting end part 14. The inserting end part 14 is accommodated in the male housing 10. In the following description, a direction orthogonal to the circuit board 12 and the mounting surfaces 13 is used as a synonym with the vertical direction.

A terminal module 15 is mounted on each of the both front and back mounting surfaces 13 of the inserting end part 14. The terminal module 15 is configured by assembling one mounting member 16 and a plurality of board-side terminals 20. The mounting member 16 is a single component made of synthetic resin and has a shape elongated in a width direction along the inserting end part 14. The mounting member 16 is integrally formed with a plurality of supporting portions 17 projecting in a direction away from the mounting surface 13 and arranged at fixed intervals in a lateral direction. A projection-like retaining portion 18 is formed on one of both left and right side surfaces of the supporting portion 17.

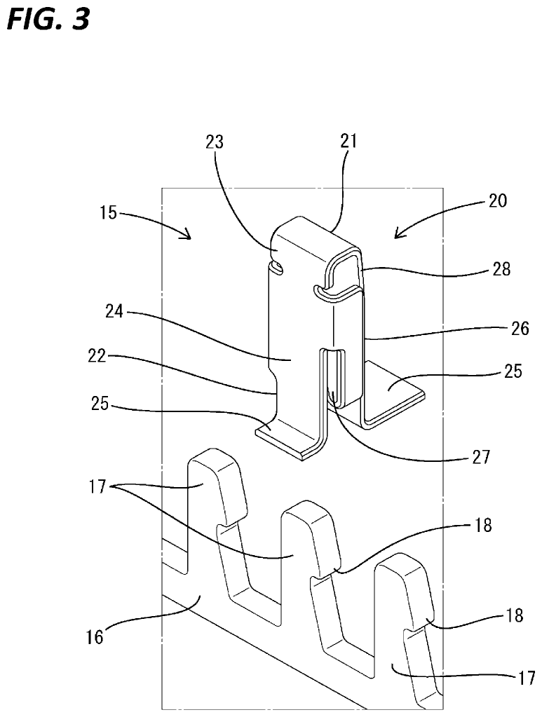

The board-side terminal 20 is formed by bending a metal plate material. As shown in FIGS. 3 to 5, the board-side terminal 20 is a single component including a vertically long box portion 21 open to face the mounting surface 13, two front and rear seating surface portions 25 and a hooking portion 27. An end part of the box portion 21 near the mounting surface 13 serves as a board contact portion 22 to be fixed to the mounting surface 13 by solder S. A region of the box portion 21 on a side opposite to the mounting surface 13 across the board contact portion 22 serves as a terminal contact portion 23, with which a resilient contact piece 44 of a terminal fitting 40 is brought into contact.

A part of the board contact portion 22 constituting a front plate portion 24 of the box portion 21 is formed with the front seating surface portion 25. The front seating surface portion 25 projects forward in parallel to the mounting surface 13 from the front plate portion 24. A part of the board contact portion 22 constituting a rear plate portion 26 of the box portion 21 is formed with the rear seating surface portion 25. The rear seating surface portion 25 projects rearward in parallel to the mounting surface 13 from the rear plate portion 26.

The hooking portion 27 projects to be folded in an oblique direction inwardly of the box portion 21 from an end edge on an open surface side of one side plate portion, out of both left and right side plate portions constituting the box portion 21. The terminal contact portion 23 is formed with a curved surface portion 28. The curved surface portion 28 is formed on an end part of the rear plate portion 26 constituting the box portion 21 opposite to an open end, and has an arcuate shape when the board-side terminal 20 is viewed laterally. The curved surface portion 28 is shaped along a displacement path of the terminal fitting 40 to be described later. The terminal contact portion 23 is formed with a contact surface 29. The contact surface 29 is formed in a region closer to the mounting surface 13 than the curved surface portion 28, out of the outer surface of the rear plate portion 26, and the resilient contact piece 44 of the terminal fitting 40 to be described later resiliently contacts the contact surface 29.

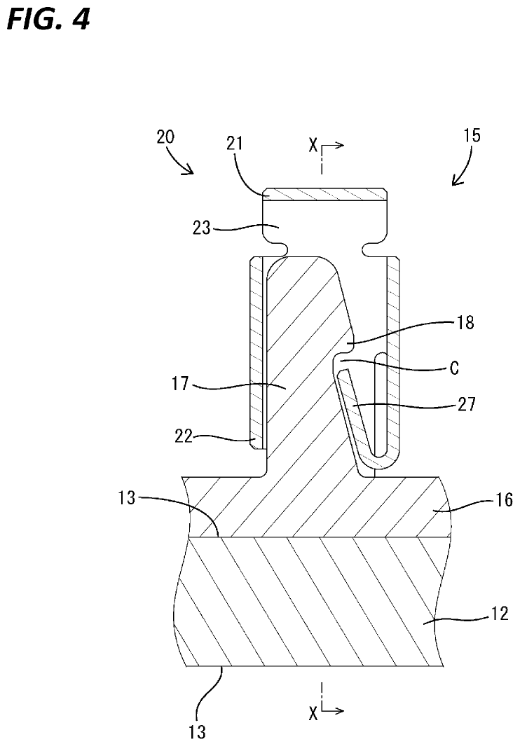

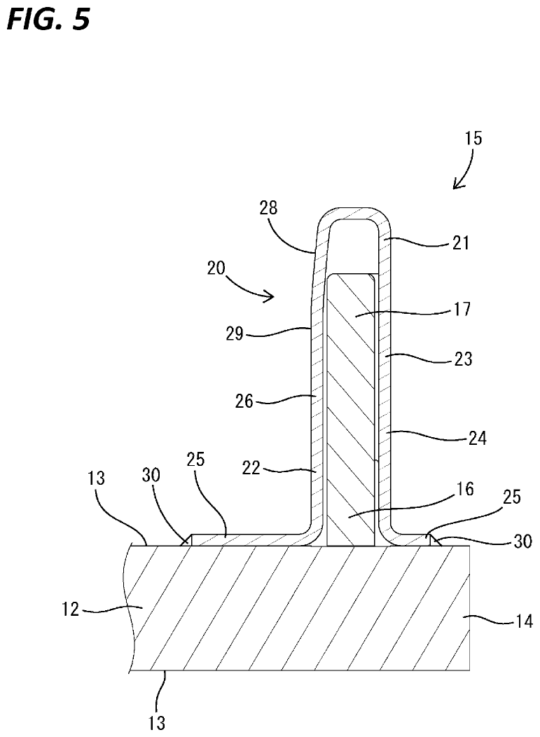

As shown in FIGS. 4 and 5, the board-side terminal 20 is so mounted as to put the box portion 21 on the supporting portion 17. Since a clearance C is secured between a projecting end part of the hooking portion 27 and the retaining portion 18 with the board-side terminal 20 mounted on the supporting portion 17, the board-side terminal 20 is relatively displaceable in a direction perpendicular to the mounting surface 13 with respect to the supporting portion 17. When the board-side terminal 20 is displaced in a direction separating from the mounting surface 13, the projecting end part of the hooking portion 27 butts against the hooking portion 27, wherefore the board-side terminal 20 is not separated from the supporting portion 17.

The terminal module 15 is mounted on the mounting surface 13 with the plurality of board-side terminals 20 individually mounted on the plurality of supporting portions 17. With the terminal module 15 mounted on the mounting surface 13, the mounting member 16 is fixed to the mounting surface 13 by welding. The both front and rear seating surface portions 25 are electrically conductively fixed to the printed circuit (not shown) on the mounting surface 13 by the solder S. Since the board-side terminals 20 are not fixed to the supporting portions 17 and are relatively displaceable with respect to the supporting portions 17, the seating surface portions 25 can be reliably fixed to the mounting surface 13. Since the solder S contacts only the seating surface portions 25 without contacting the front plate portions 24 and the rear plate portions 26 perpendicular to the mounting surface 13, the solder S does not spread to the contact surfaces 29 of the front plate portions 24. In the above way, the plurality of board-side terminals 20 are mounted side by side at fixed intervals in a row in the lateral direction on each of the front and back mounting surfaces 13 of the inserting end part 14 via the mounting member 16.

As shown in FIG. 2, the female connector F includes a female housing 30 and a plurality of the terminal fittings 40. The female housing 30 includes a pair of first housings 31 vertically symmetrical across the circuit board 12, the plurality of terminal fittings 40, one second housing 32 and one third housing 33. The first housings 31 are made of synthetic resin and have a flat rectangular parallelepiped shape parallel to the mounting surfaces 13. As shown in FIG. 2, cylindrical guide pins 34 having an axis oriented in the lateral direction and cylindrical shaft portions 35 having an axis oriented in the lateral direction are formed on both left and right outer side surfaces of the first housing 31. The guide pins 34 are located in a front end part of the first housing 31. The shaft portions 35 are located in a rear end part of the first housing 31.

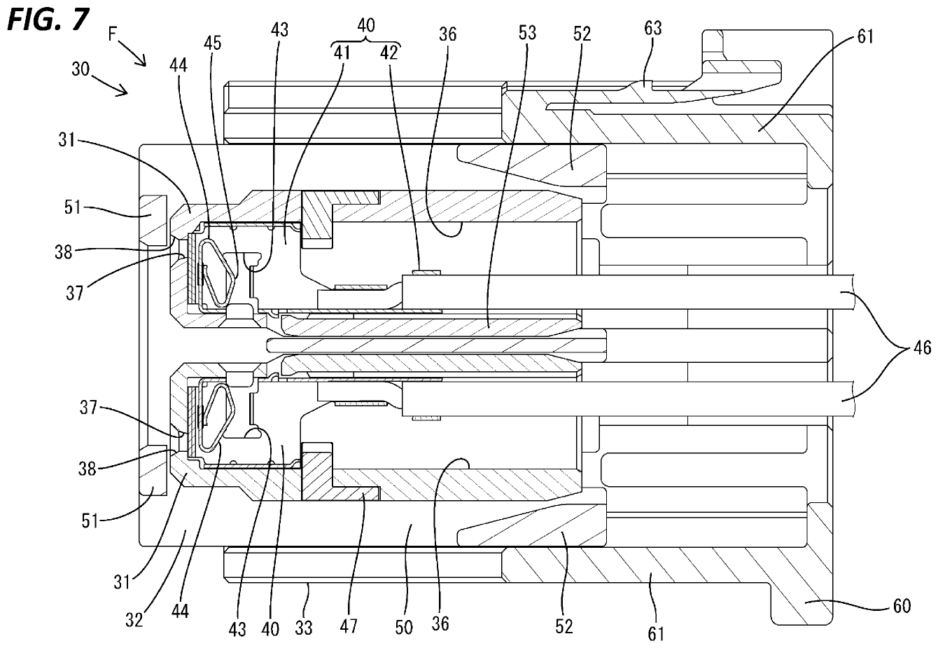

As shown in FIGS. 7, 9 and 11, a plurality of terminal accommodation chambers 36 elongated in the front-rear direction are formed side by side in a row in the lateral direction in the first housing 31. The first housing 31 is formed with a plurality of openings 37 open in the front end surface of the first housing 31 and individually communicating the front ends of the plurality of terminal accommodation chambers 36. An expanded portion 38 expanded toward the front end surface side of the first housing 31 is formed in the inner peripheral surface of the opening 37. The terminal fitting 40 fixed to a front end part of a wire 46 is accommodated in each terminal accommodation chamber 36. The terminal fitting 40 accommodated in the terminal accommodation chamber 36 is retained by a retainer 47 mounted into the first housing 31. The wire 46 is drawn out rearward from the rear end of the first housing 31.

As shown in FIGS. 7, 9 and 11, the terminal fitting 40 is a single component including a terminal body portion 41 and a crimping portion 42. The terminal body portion 41 constitutes a front end part of the terminal fitting 40. The terminal body portion 41 is formed with a recess 43 and the resilient contact piece 44. The recess 43 is open in a surface of the terminal body portion 41 facing the mounting surface 13 and both left and right side surfaces of the terminal body portion 41. The resilient contact piece 44 is arranged along a front inner surface, out of the inner surface of the recess 43. A contact point portion 45 of the resilient contact piece 44 is located in a region closer to the mounting surface 13 than a center of the resilient contact piece 44 in a direction orthogonal to the mounting surface 13. The crimping portion 42 is located in a rear end part of the terminal fitting 40. The crimping portion 42 is crimped to the wire 46.

The second housing 32 is a single component made of synthetic resin and shaped to be bilaterally and vertically symmetrical. As shown in FIG. 2, the second housing 32 includes a pair of side surface portions 50, a pair of front coupling portions 51, a pair of rear coupling portions 52 and a stopper 53. The front coupling portions 51 couple front end parts of the side surface portions 50 on both upper and lower end edges. The rear coupling portions 52 couple rear end parts of the side surface portions 50 on both upper and lower end edges. The stopper 53 is in the form of a flat plate parallel to the mounting surface 13 and couples vertical centers of the both left and right side surface portions 50.

As shown in FIGS. 2, 6, 8 and 10, each of the both left and right side surface portions 50 is formed with a pair of vertically symmetrical slide grooves 54. The slide grooves 54 linearly extend in the front-rear direction, i.e. a direction parallel to a fitting direction of the circuit board 12 and the female connector F. Each of the both left and right side surface portions 50 is formed with a pair of vertically symmetrical guide grooves 55. The guide grooves 55 are continuous with the front ends of the slide grooves 54 and arcuately extend to be vertically separated from each other.

Each of the both left and right side surface portions 50 is formed with a pair of vertically symmetrical resilient holding pieces 56. The resilient holding pieces 56 are cantilevered rearward along the slide grooves 54. The resilient holding pieces 54 are resiliently deformable in the vertical direction to be separated from each other. A holding projection 57 projecting into the slide groove 54 is formed on a rear end part (extending end part) of the resilient holding piece 56. The holding projection 57 constitutes a rear end part of the slide groove 54. The rear end of the slide groove 54 is open to a rear outer side of the second housing 32.

The third housing 33 is a single component made of synthetic resin and shaped to be bilaterally and vertically symmetrical. As shown in FIG. 2, the third housing 33 includes a frame portion 60, a pair of vertically symmetrical supporting wall portions 61 and a pair of bilaterally symmetrical side wall portions 62. The frame portion 60 is arranged in a rear end part of the third housing 33 and has a rectangular shape when the third housing 33 is viewed from behind. The pair of supporting wall portions 61 project forward from both upper and lower edge parts of the frame portion 60. One supporting wall portion 61 is formed with a lock arm 63.

The pair of side wall portions 62 project forward from both left and right side edge parts of the frame portion 60. Both left and right side edges of the supporting wall portions 61 are connected at a right angle to upper or lower edge parts of the both left and right side wall portions 62. Each of the both left and right side wall portions 62 is formed with a pair of vertically symmetrical guide portions 64. The guide portion 64 is in the form of a slit extending in the front-rear direction as a whole. The guide portion 64 is formed by successively connecting a first guide 65, a second guide 66, a third guide 67 and a fourth guide 68 from a front end to a rear end.

A pair of vertically symmetrical first guides 65 are inclined with respect to the front-rear direction to be separated from each other from the front end toward the rear end. A pair of vertically symmetrical second guides 66 are parallel to the front-rear direction. A pair of vertically symmetrical third guides 67 are inclined with respect to the front-rear direction to approach each other from the front end toward the rear end. A pair of vertically symmetrical fourth guides 68 are parallel to the front-rear direction. The rear ends of the fourth guides 68 are open in the rear end surface of the third housing 33.

The female connector F is assembled in the following procedure. First, the both upper and lower first housings 31 are assembled with the third housing 33 from behind and the guide pins 34 and the shaft portions 35 are fit into the guide portions 64. As the first housings 31 are assembled, the guide pins 34 successively slide in contact with the fourth guides 68, the third guides 67, the second guides 66 and the first guides 65.

The assembling of the first housings 31 is completed when the guide pins 34 butt against the front ends of the first guides 65 as shown in FIG. 6. In an assembling process of the first housings 31, the shaft portions 35 are fit in the fourth guides 68 when the guide pins 34 reach front end parts of the fourth guides 68. When the assembling of the first housings 31 is completed, the shaft portions 35 are located in front end parts of the fourth guides 68. The guide pins 34 and the shaft portions 35 cannot be relatively displaced in the vertical direction with respect to the guide portions 64, but can be relatively displaced in the front-rear direction along the guide portions 64.

Thereafter, the second housing 32 is assembled with the first housings 31 and the third housing 33 from front. In an assembling process of the second housing 32, the holding projections 57 interfere with the guide pins 34, whereby the resilient holding pieces 56 are resiliently deformed and the guide pins 34 are fit into rear end parts of the slide grooves 54. As the second housing 32 is further assembled, the holding projections 57 interfere with the shaft portions 35, whereby the resilient holding pieces 56 are resiliently deformed. When the resilient holding pieces 56 resiliently return and the shaft portions 35 are fit into the rear end parts of the slide grooves 54 as shown in FIG. 6, the assembling of the second housing 32 with the first housings 31 and the third housing 33 is completed.

With the assembling of the second housing 32 completed, the guide pins 34 are in contact with or proximately facing the front ends of the slide grooves 54 from behind and the shaft portions 35 are in contact with or proximately facing the rear ends (holding projections 57) of the slide grooves 54. The guide pins 34 and the shaft portions 35 are sandwiched in the front-rear direction between the front and rear ends of the slide grooves 54, whereby the first housings 31 and the second housing 32 are assembled with relative displacements in the front-rear direction restricted.

The second and third housings 32, 33 can be relatively displaced in the front-rear direction. As the second and third housings 32, 33 are relatively displaced in the front-rear direction, the guide pins 34 slide between the first and fourth guides 65, 68 and the shaft portions 38 slide in the front-rear direction in the fourth guides 68. Since the front ends of the slide grooves 54 communicate with the guide grooves 55 in the vertical direction, the first housings 31 can swing in the vertical direction with respect to the second housing 32 with the shaft portions 35 as fulcrums while the guide pins 34 are moved in the guide grooves 55.

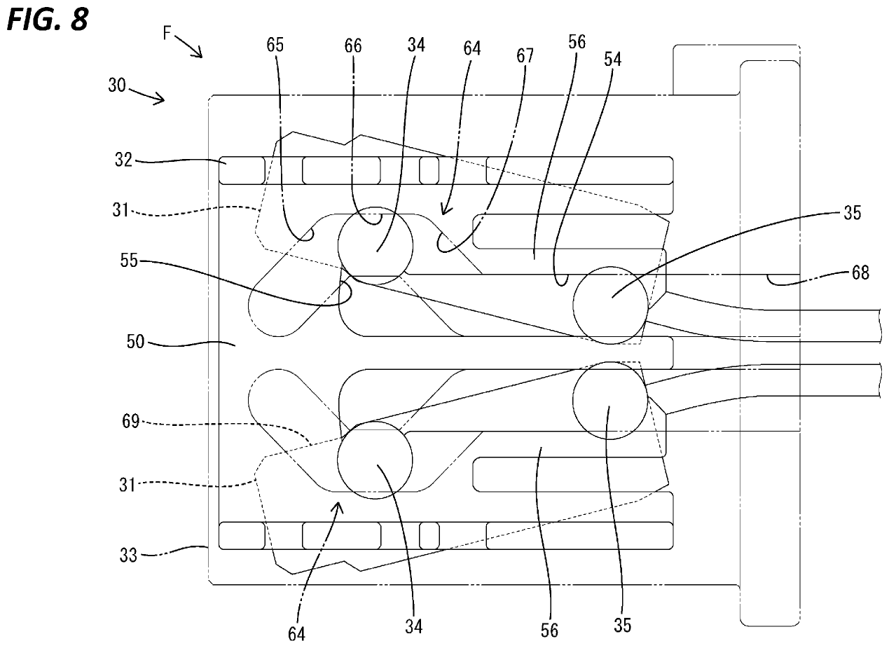

In connecting the female connector F and the male connector M, the both upper and lower first housings 31 are displaced to non-connection positions (see FIGS. 8 and 9) separated from each other in advance. Specifically, the third housing 33 is relatively displaced forward with respect to the first housings 31 and the second housing 32 from a state where the guide pins 34 are located in the front ends of the first guides 65. The guide pins 34 slide in contact with the first guides 65, whereby the first housings 31 swing to be separated from each other and displaced to the non-connection positions with the shaft portions 35 as fulcrums. When the guide pins 34 enter the second guides 66, the second and third housings 32, 33 are held not to be shifted.

When the first housings 31 are held at the non-connection positions, an insertion space 69 into which the circuit board 12 can be inserted without the board-side terminals 20 interfering with the first housings 31 is secured between the both upper and lower first housings 31 as shown in FIG. 9. In this state, the male housing 10 and the third housing 33 are gripped to start the connection of the male connector M and the female connector F, and the inserting end part 14 of the circuit board 12 is inserted into the insertion space 69 and butted against the front end of the stopper 53 as shown in FIG. 9. In this state, the recesses 43 of the terminal fittings 40 are facing the board-side terminals 20 in the vertical direction.

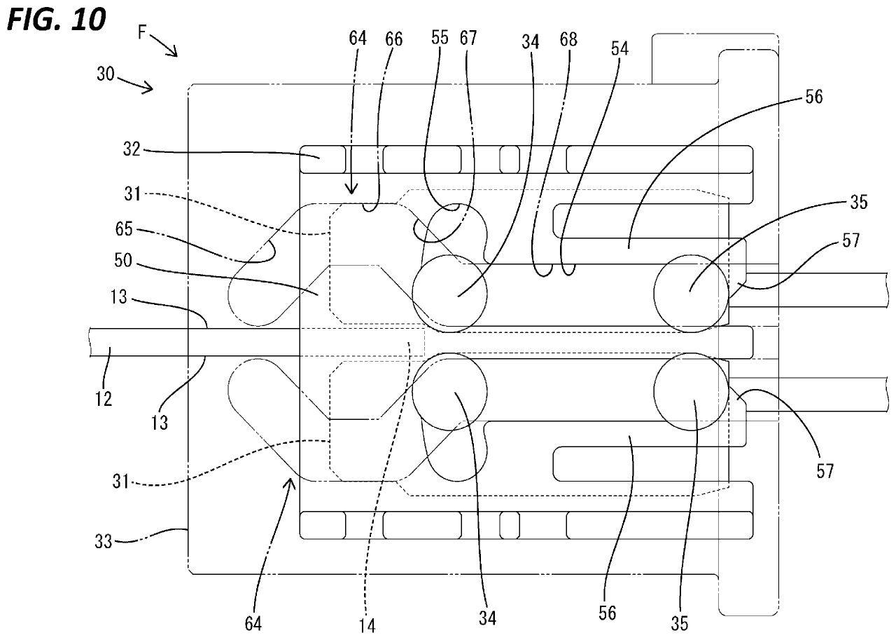

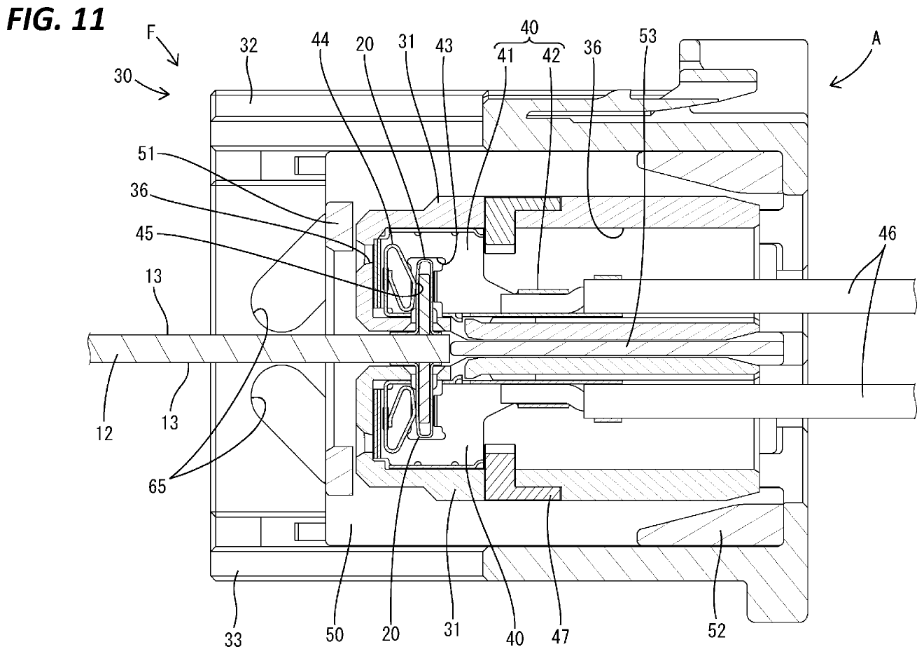

If the connection of the both connectors F, M further proceeds from the state where the inserting end part 14 of the circuit board 12 is butted against the stopper 53, the third housing 33 is relatively displaced forward with respect to the second housing 32, wherefore the guide pins 34 move from the second guides 66 to the third guides 67. Since the third guides 67 are inclined with respect to the front-rear direction, the both upper and lower first housings 31 at the non-connection positions approach each other by the guide pins 34 sliding in contact with the third guides 67. The guide pins 34 move in the guide grooves 55 of the second housing 32 while sliding in contact with the third guides 67. When the guide pins 34 reach the fourth guides 68 as shown in FIG. 10, the first housings 31 reach connection positions (see FIGS. 10, 11).

In the process of displacing the first housings 31 to the connection positions, the recesses 43 of the terminal fittings 40 are fit to the board-side terminals 20 and the resilient contact pieces 44 contact the board-side terminals 20. During this time, the resilient contact pieces 44 slide in contact with the curved surface portions 28 of the board-side terminals 20 while being resiliently deformed. Since the curved surface portions 28 have an arcuate shape centered on the shaft portions 35 of the first housings 31, resilient deformation amounts of the resilient contact pieces 44 are kept constant while the resilient contact pieces 44 are sliding in contact with the curved surface portions 28.

When the first housings 31 reach the connection positions, the contact point portions 45 of the resilient contact pieces 44 are resiliently in contact with the contact surfaces 29 as shown in FIG. 11. Since the outer surfaces of the curved surface portions 28 and the contact surfaces 29 are smoothly connected, the resilient deformation amounts of the resilient contact pieces 44 do not vary when the resilient contact pieces 44 move from the curved surface portions 28 to the contact surfaces 29. When the contact point portions 45 reach the contact surfaces 29, the connection of the male connector M and the female connector F is completed. When the both connectors F, M are connected, the lock arm 63 of the third housing 33 is locked into the lock hole 11 of the male housing 10, whereby the both connectors F, M are locked in the connected state.

With the terminal fitting 40 and the board-side terminal 20 connected, the resilient contact piece 44 resiliently presses the board-side terminal 20 from front and the board-side terminal 20 is pressed against the inner surface on the rear side of the recess 43. When the wire 46 is pulled rearward, the resilient contact piece 44 is resiliently deformed to relatively displace the terminal fitting 40 with respect to the board-side terminal 20, whereby a load to the board-side terminal 20 is reduced.

As shown in FIG. 9, a rear end part of the first housing 31 is formed with a tapered portion 39 by cutting a region facing the stopper 53 of the second housing 32. By forming the first housing 31 with the tapered portion 39, the interference of the first housing 31 and the second housing 32 is prevented in the process of swinging the first housing 31 between the connection position and the non-connection position. In this way, the first housing 31 is swung without any problem.

The first housing 31 is formed with the openings 37 open in the front end surface of the first housing 31 and communicating with the insides of the terminal accommodation chambers 36. The opening 37 is provided with the expanded portion 38 expanded toward the front end surface of the first housing 31. According to this configuration, regardless of at which of the connection position and the non-connection position the first housing 31 is located, a continuity inspection of inserting a probe (not shown) into the opening 37 and bringing the probe into contact with the terminal fitting 40 can be performed.

In separating the both connectors F, M in the connected state, the lock arm 63 is unlocked to release the locking of the lock arm 63 and the lock hole 11 and the third housing 33 is pulled in a direction to be separated from the male connector M. Then, the guide pins 34 slide in contact with the third guides 67, whereby the first housings 31 are displaced from the connection positions to the non-connection positions. When the guide pins 34 reach the second guides 66, the recesses 43 of the terminal fittings 40 are disengaged from the board-side terminals 20. Thereafter, the third and second housings 33, 32 may be integrally moved and separated from the male housing 10.

The card edge connector A of the first embodiment includes the female housing 30, the terminal fittings 40 mounted in the female housing 30 and the circuit board 12. The circuit board 12 has the mounting surfaces 13 and is fit into the female housing 30 in parallel to the mounting surfaces 13. The circuit board 12 is provided with the plurality of board-side terminals 20 projecting from the mounting surfaces 13. The terminal fitting 40 is formed with the recess 43 open to face the mounting surface 13 and configured to accommodate the board-side terminal 20. The resilient contact piece 44 provided in the recess 43 resiliently contacts the board-side terminal 20. According to the above configuration, when the resilient contact piece 44 resiliently contacts the board-side terminal 20, a reaction force from the board-side terminal 20 is received by the terminal fitting 40. Even if the housing is thermally deformed or the thickness of the circuit board 12 varies, a contact pressure between the terminal fitting 40 and the board-side terminal 20 is stable.

To fit the recess 43 of the terminal fitting 40 to and bring the resilient contact piece 44 into contact with the board-side terminal 20 projecting from the mounting surface 13 of the circuit board 12, the terminal fitting 40 needs to be displaced in directions toward and away from the mounting surface 13. If the terminal fitting 40 is parallelly moved in a direction orthogonal to the mounting surface 13, a structure for guiding the terminal fitting 40 becomes complicated.

Accordingly, in the card edge connector A of the first embodiment, the terminal fitting 40 is so supported in the female housing 30 as to be swingable with the shaft portions 35 as the fulcrums. The terminal fitting 40 swings between the connection position near the mounting surface 13 and the non-connection position separated from the mounting surface 13. With the terminal fitting 40 located at the connection position, the resilient contact piece 44 is in contact with the board-side terminal 20. With the terminal fitting 40 located at the non-connection position, the resilient contact piece 44 is not in contact with the board-side terminal 20. Since the terminal fittings 40 are swung in the card edge connector A of the first embodiment, the structure for guiding the terminal fittings 40 can be simplified.

To displace the terminal fitting 40 from the non-connection position to the connection position and bring the terminal fitting 40 into contact with the board-side terminal 20, it is considered to swing the terminal fitting 40 from the non-connection position to the connection position while the circuit board 12 is inserted into the female housing 30. However, since the circuit board 12 and the terminal fitting 40 are relatively displaced in two different directions in this case, a relative displacement path of the resilient contact piece 44 with respect to the board-side terminal 20 becomes unstable and the resilient contact piece 44 may interfere with the board-side terminal 20.

As a countermeasure against that, the female housing 30 of the first embodiment includes the first housings 31, the second housing 32 and the third housing 33 for holding the terminal fittings 40. The second housing 32 includes the stopper 53, against which the inserting end part 14 of the circuit board 12 butts. The first housings 31 and the second housing 32 are restricted from being relatively displaced in the direction parallel to the fitting direction of the female housing 30 and the circuit board 12. The second housing 32 holds the first housings 31 such that the first housings 31 are swingable between the connection positions and the non-connection positions with the shaft portions 35 as the fulcrums. The third housing 33 is relatively displaceable in parallel to the fitting direction of the female housing 30 and the circuit board 12 with respect to the second housing 32. The third housing 33 is formed with the guide portions 64 for displacing the first housings 31 between the connection positions and the non-connection positions as the second and third housings 32, 33 are relatively displaced.

According to this configuration, the terminal fittings 40 are swung with the shaft portions 35 as the fulcrums in a state where the inserting end part 14 of the circuit board 12 is butted against the stopper 53 of the second housing 32. Since the shaft portions 35 are not relatively displaced in the front-rear direction with respect to the stopper 53, relative displacement paths of the resilient contact pieces 44 with respect to the board-side terminals 20 are stabilized. In this way, the resilient contact pieces 44 and the board-side terminals 20 can be connected without interfering with each other.

The second housing 32 is formed with the resilient holding pieces 56 for holding the first housings 31 in a state assembled with the second housing 32 by being resiliently deformed in the process of assembling the first housings 31 with the second housing 32. According to this configuration, the first housings 31 are easily assembled with the second housing 32.

The second housing 32 is formed with the guide grooves 55 along swing paths of the first housings 31. The first housings 31 are formed with the guide pins 34 and the shaft portions 35. The guide pins 34 can slide in contact with the guide grooves 55 from behind. The shaft portions 35 are locked to the resilient holding pieces 56 from front. According to this configuration, the first housings 31 can be positioned in the front-rear direction and held with respect to the second housing 32 even without forming circular bearing holes in the second housing 32.

The plurality of board-side terminals 20 are arranged side by side in a row along the inserting end part 14 of the mounting surface 13. The recesses 43 penetrate in the same direction as an arrangement direction of the board-side terminals 20. According to this configuration, position shifts of the board-side terminals 20 and the terminal fittings 40 in the arrangement direction of the board-side terminals 20 can be absorbed.

The wire 46 is connected to the rear end part of the terminal fitting 40. The resilient contact piece 44 is arranged along the inner surface on the front side of the recess 43. According to this configuration, when the wire 46 is pulled rearward, the resilient contact piece 44 is resiliently deformed, thereby reducing a load to the board-side terminal 20.

The contact point portion 45 of the resilient contact piece 44 is arranged in the region closer to the mounting surface 13 than the center of the resilient contact piece 44 in a projecting direction of the board-side terminal 20. According to this configuration, since a contact position of the board-side terminal 20 and the contact point portion 45 of the resilient contact piece 44 is near the mounting surface 13, a projection dimension of the board-side terminal 20 from the mounting surface 13 can be reduced.

The circuit board 12 of the first embodiment has the mounting surfaces 13 and the plurality of board-side terminals 20 projecting from the mounting surfaces 13. The terminal fittings 40 mounted in the female housing 30 are in contact with the board-side terminals 20 with the circuit board 12 fit in the female housing 30 in parallel to the mounting surfaces 13. In the case of individually mounting the plurality of board-side terminals 20 on the circuit board 12, many mounting steps are performed for the circuit board 12. As a countermeasure against this, the single mounting member 16 including the plurality of supporting portions 17 is mounted on the mounting surface 13. The plurality of board-side terminals 20 are individually mounted on the plurality of supporting portions 17. According to this configuration, the mounting member 16 may be mounted on the mounting surface 13 after the plurality of board-side terminals 20 are mounted on the plurality of supporting portions 17. Thus, the mounting member 16 can be mounted on the mounting surface 13 with one action.

If the board-side terminals 20 are fixedly mounted on the supporting portions 17, mounted positions of the board-side terminals 20 on the supporting portions 17 possibly vary due to dimensional tolerances of the supporting portions 17 and the board-side terminals 20. If the mounted positions of the board-side terminals 20 on the supporting portions 17 vary, there is a concern that the board-side terminals 20 are not in contact with the mounting surface 13. As a countermeasure against this, the supporting portion 17 is formed with the retaining portion 18 in the circuit board 12 of the first embodiment. The retaining portion 18 prevents the separation of the board-side terminal 20 by locking the hooking portion 27 of the board-side terminal 20. The clearance C in the direction parallel to the projecting direction of the board-side terminal 20 from the mounting surface 13 is secured between the hooking portion 27 and the retaining portion 18. Since the clearance C is provided between the retaining portion 18 of the supporting portion 17 and the board-side terminal 20, the board-side terminal 20 can be reliably brought into contact with the mounting surface 13 by its own weight if the mounting surface 13 is horizontally arranged.

The board-side terminal 20 includes the board contact portion 22 to be fixed to the mounting surface 13 by the solder S and the terminal contact portion 23. The terminal contact portion 23 is located on the side opposite to the mounting surface 13 across the board contact portion 22. The resilient contact piece 44 of the terminal fitting 40 contacts the terminal contact portion 23. The board contact portion 22 is formed with the seating surface portion 25 parallel to the mounting surface 13 of the circuit board 12 and projecting toward the contact surface 29 with the terminal fitting 40 in the terminal contact portion 23. By forming the seating surface portion 25, a close contact region of the solder S with the board contact portion 22 is within the thickness of the seating surface portion 25. Therefore, there is no possibility that the solder S spreads up to the contact surface 29 with the terminal fitting 40 in the terminal contact portion 23.

The board-side terminal 20 is formed with the curved surface portion 28 along the displacement path of the terminal fitting 40 swinging with the shaft portions 35 as the fulcrums. The resilient contact piece 44 of the terminal fitting 40 slides in contact with the curve surface portion 28 while being resiliently deformed. According to this configuration, since the resilient displacement amount of the resilient contact piece with respect to the board-side terminal 20 is stabilized in the process of swinging the terminal fitting 40, resistance in swinging the terminal fitting 40 is stabilized.

### Second Embodiment

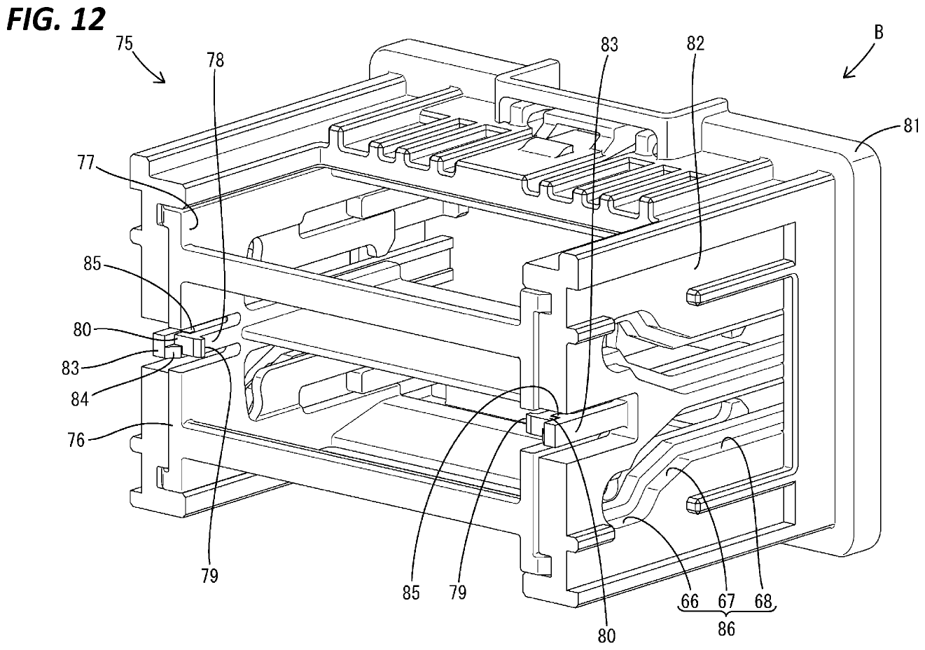

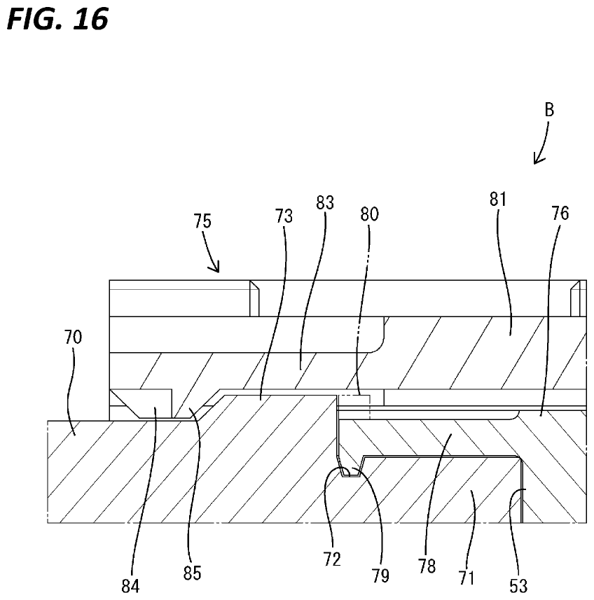

A specific second embodiment of a card edge connector B of the present disclosure is described below with reference to FIGS. 12 to 16. The card edge connector B of the second embodiment is provided with a locking structure for a circuit board 70 and a female housing 75. Since the other configuration is the same as in the first embodiment, the same components are denoted by the same reference signs and the structures, functions and effects thereof are not described.

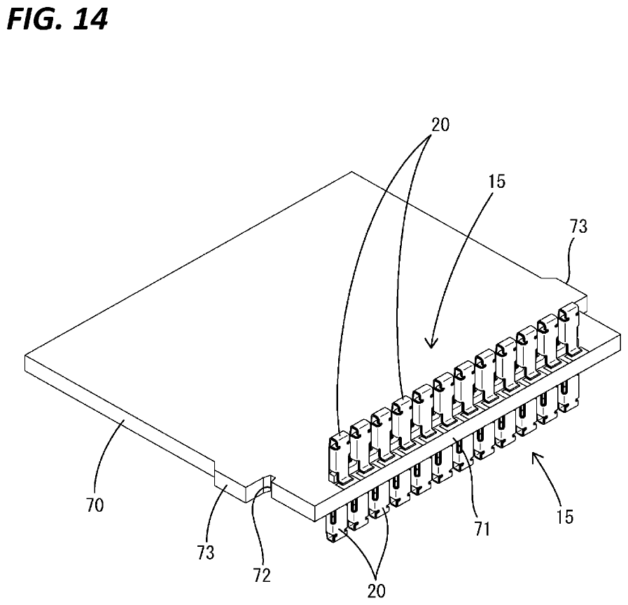

As shown in FIG. 14, an inserting end part 71 of the circuit board 70 is formed with a pair of bilaterally symmetrical second locking portions 72 and a pair of bilaterally symmetrical third locking portions 73. The second locking portions 72 are formed by recessing parts of both left and right side edges of the inserting end part 71 slightly behind (toward a side opposite to a fitting direction of the circuit board 70 into the female housing 75) board-side terminals 20 (terminal modules 15). The third locking portions 73 are projecting parts slightly behind the second locking portions 72, out of the both left and right side edges of the inserting end part 71.

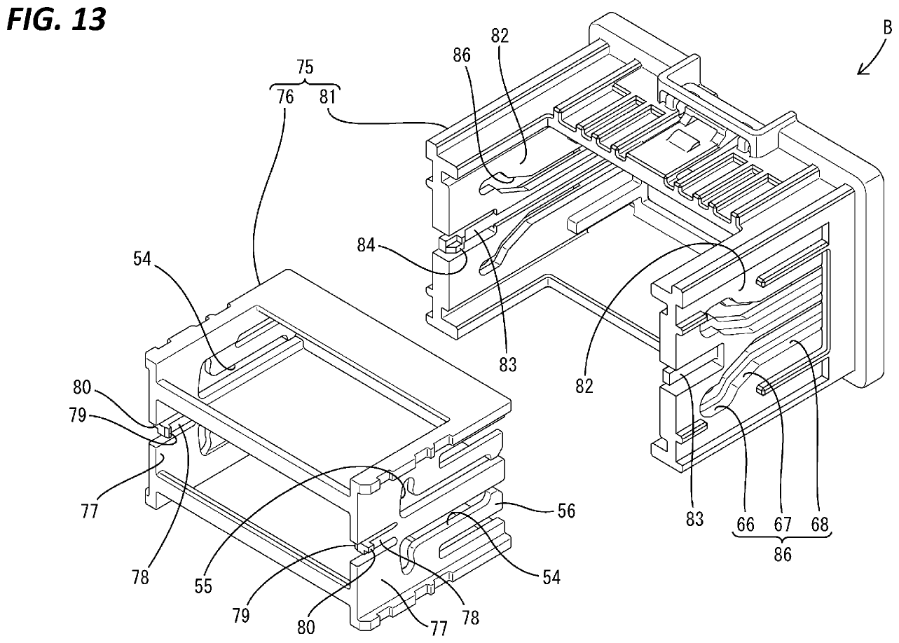

As shown in FIGS. 12 and 13, both left and right side wall portions 72 of a second housing 77 are formed with a pair of second resilient locking pieces 78. The second resilient locking piece 78 is located in a front end part of the side wall portion 72 and cantilevered forward (in the same direction as a fitting direction of the female housing 75 to the circuit board 70). Each of the both left and right second resilient locking pieces 78 is formed with a second locking projection 79 projecting inward (toward the mating second resilient locking piece 78). Each of the both left and right second resilient locking pieces 78 is formed with a pressure receiving portion 80 projecting outward (toward a side opposite to the mating second resilient locking piece 78).

Both left and right side wall portions 82 of a third housing 81 are formed with a pair of third resilient locking pieces 83. The third resilient locking piece 83 is located in a front end part of the side wall portion 82 and cantilevered forward. Each of the both left and right third resilient locking pieces 83 is formed with a third locking projection 84 projecting inward (toward the mating third resilient locking piece 83) and a pressing portion 85 projecting inwardly. Guide portions 86 formed in the side wall portion 82 of the third housing 81 include no first guide unlike the guide portions 64 of the first embodiment. That is, the guide portion 86 of the second embodiment is composed of the second guide 66, the third guide 67 and the fourth guide 68 in the first embodiment.

In fitting the female housing 75 and the circuit board 70, the third housing 81 is gripped and pushed to approach the circuit board 70. If the third housing 81 is pushed, the pressing portions 85 push the pressure receiving portions 80, whereby the second housing 76 moves integrally with the third housing 81 and approaches the circuit board 70.

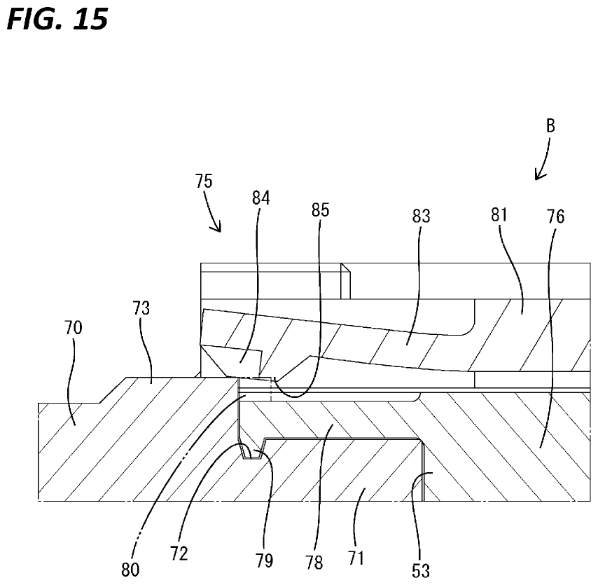

When the inserting end part 71 of the circuit board 70 butts against a stopper 53 of the second housing 76 as shown in FIG. 15, the second locking projections 79 are fit to the second locking portions 72 to inseparably lock the circuit board 70 and the second housing 76. At this time, since the third locking projections 84 ride on the third locking portions 73, the third resilient locking pieces 83 are resiliently deformed to separate the pressing portions 85 from the pressure receiving portions 80.

If the third housing 81 is further pushed toward the second housing 76 from this state, the third housing 81 relatively moves with respect to the circuit board 70 and the second housing 76. If the third housing 81 is relatively displaced with respect to the second housing 76, guide pins (not shown) of first housings 31 (not shown) fit in the second guides 66 slide in contact with the third guides 67, and the first housings 31 swing from non-connection positions to connection positions. If the first housings 31 swing from the non-connection positions to the connection positions, terminal fittings 40 (not shown) and the board terminals 20 are connected. If the female housing 75 and the circuit board 70 are properly fit, the third resilient locking pieces 83 resiliently return and the third locking projections 84 are locked to the third locking portions 73. By this locking, the female housing 75 and the circuit board 70 are held in the fit state.

The circuit board 70 of the second embodiment is formed with the second locking portions 72 and the third locking portions 73. The second locking portions 72 resiliently lock the second resilient locking pieces 78 of the second housing 76 with the circuit board 70 butted against the stopper 53. The third locking portions 73 resiliently lock the third resilient locking pieces 83 of the third housing 81 with the first housings 31 displaced to the connection positions.

In a state where neither the second housing 76 nor the third housing 81 is locked to the circuit board 70, the second and third housings 76, 81 individually rattle with respect to the circuit board 70. In the second embodiment, since the second and third housings 76, 81 are individually and resiliently locked to the circuit board 70, the rattling of the second housing 76 with respect to the circuit board 70 and the rattling of the third housing 81 with respect to the circuit board 70 can be prevented.

[Other Embodiments] The present invention is not limited to the above described and illustrated embodiments and is represented by claims. The present invention is intended to include all changes in the scope of claims and in the meaning and scope of equivalents and also include the following embodiments.

Although the terminal fittings and the first housings swing in the above first embodiment, the terminal fittings and the first housings may parallelly move.

Although the first housing is formed with the tapered portion for avoiding interference with the second housing in the above first embodiment, the first housing may not include such a tapered portion.

Although the second housing holds the first housings by the resilient holding pieces in the above first embodiment, the first housings may be held by fitting the shaft portions of the first housings into bearing holes formed in the second housing.

Although the recess penetrates in the arrangement direction of the board-side terminals in the above first embodiment, the recess may be formed to surround the board-side terminal over an entire periphery.

Although the resilient contact piece is arranged along the front wall portion of the recess in the above first embodiment, the resilient contact piece may be arranged along the rear wall surface of the recess.

Although the plurality of board-side terminals are mounted on the mounting surface via one mounting member in the above first embodiment, the plurality of board-side terminals may be individually mounted on the mounting surface.

Although the board-side terminal is relatively displaceably mounted on the supporting portion in the above first embodiment, the board-side terminal may be fixed to the supporting portion.

### List of Reference Numerals

10 male housing

11 lock hole

12 circuit board

13 mounting surface

14 inserting end part

15 terminal module

16 mounting member

17 supporting portion

18 retaining portion

20 board-side terminal

21 box portion

22 board contact portion

23 terminal contact portion

24 front plate portion

25 seating surface portion

26 rear plate portion

27 hooking portion

28 curved surface portion

29 contact surface

30 female housing (housing)

31 first housing

32 second housing

33 third housing

34 guide pin

35 shaft portion

36 terminal accommodation chamber

37 opening

38 expanded portion

39 tapered portion

40 terminal fitting

41 terminal body portion

42 crimping portion

43 recess

44 resilient contact piece

45 contact point portion

46 wire

47 retainer

50 side surface portion

51 front coupling portion

52 rear coupling portion

53 stopper

54 slide groove

55 guide groove

56 resilient holding piece

57 holding projection

60 frame portion

61 supporting wall portion

62 side wall portion

63 lock arm

64 guide portion

65 first guide

66 second guide

67 third guide

68 fourth guide

69 insertion space

70 circuit board

71 inserting end part

72 second locking portion

73 third locking portion

75 female housing

76 second housing

77 side surface portion

78 second resilient locking piece

79 second locking portion

80 pressure receiving portion

81 third housing

82 side wall portion

83 third resilient locking piece

84 third locking projection

85 pressing portion

86 guide portion

A card edge connector

B card edge connector

C clearance

F female connector

M male connector

S solder

1. A card edge connector, comprising:
a housing;
a terminal fitting mounted in the housing; and
a circuit board having a mounting surface, the circuit board being fit into the housing in parallel to the mounting surface, wherein:
the circuit board is provided with a board-side terminal projecting from the mounting surface,
the terminal fitting is formed with a recess for accommodating the board-side terminal, and
a resilient contact piece provided in the recess resiliently contacts the board-side terminal.

2. The card edge connector of claim 1, wherein:
the terminal fitting is supported to be swingable between a connection position near the mounting surface and a non-connection position separated from the mounting surface with a shaft portion as a fulcrum,
the resilient contact piece is in contact with the board-side terminal with the terminal fitting located at the connection position, and
the resilient contact piece is not in contact with the board-side terminal with the terminal fitting located at the non-connection position.

3. The card edge connector of claim 2, wherein:
the housing includes:
a first housing for holding the terminal fitting;
a second housing including a stopper, an inserting end part of the circuit board butting against the stopper, the second housing holding the first housing such that the first housing is swingable between the connection position and the non-connection position with the shaft portion as the fulcrum; and
a third housing relatively displaceable in parallel to a fitting direction of the housing and the circuit board with respect to the second housing,
the first and second housings are restricted from being relatively displaced in a direction parallel to the fitting direction of the housing and the circuit board, and
the third housing is formed with a guide portion for displacing the first housing between the connection position and the non-connection position as the second and third housings are relatively displaced.

4. The card edge connector of claim 3, wherein the second housing is formed with a resilient holding piece for holding the first housing in a state assembled with the second housing by being resiliently deformed in the process of assembling the first housing with the second housing.

5. The card edge connector of claim 4, wherein:
the second housing is formed with a guide groove along a swing path of the first housing,
the first housing is formed with a guide pin and the shaft portion,
the guide pin is slidable in contact with the guide groove from behind, and
the shaft portion is locked to the resilient holding piece from front.

6. The card edge connector of claim 3, wherein:
the circuit board is formed with a second locking portion and a third locking portion,
the second locking portion is resiliently locked to a second resilient locking piece of the second housing with the circuit board butted against the stopper, and
the third locking portion resiliently locks a third resilient locking piece of the third housing with the first housing displaced to the connection position.

7. The card edge connector of claim 1, wherein:
a plurality of the board-side terminals are arranged side by side in a row, and
the recess penetrates in the same direction as an arrangement direction of the board-side terminals.

8. The card edge connector of claim 1, wherein:
a wire is connected to a rear end part of the terminal fitting, and
the resilient contact piece is arranged along an inner surface on a front side of the recess.

9. The card edge connector of claim 1, wherein a contact point portion of the resilient contact piece is arranged in a region closer to the mounting surface than a center of the resilient contact piece in a projecting direction of the board-side terminal.

10. A circuit board, comprising:
a mounting surface; and
a plurality of board-side terminals projecting from the mounting surface, wherein:
terminal fittings mounted in a housing are in contact with the board-side terminals with the circuit board fit in the housing in parallel to the mounting surface,
a single mounting member including a plurality of supporting portions is mounted on the mounting surface, and
the plurality of board-side terminals are individually mounted on the plurality of supporting portions.

11. The circuit board of claim 10, wherein:
the supporting portion is formed with a retaining portion for preventing separation of the board-side terminal by locking the board-side terminal, and
a clearance in a direction parallel to a projecting direction of the board-side terminal from the mounting surface is secured between the board-side terminal and the retaining portion.

12. The circuit board of claim 10, wherein:
the board-side terminal includes:
a board contact portion to be fixed to the mounting surface by solder; and
a terminal contact portion located on a side opposite to the mounting surface across the board contact portion, a resilient contact piece of the terminal fitting being brought into contact with the terminal contact portion, and
the board contact portion is formed with a seating surface portion parallel to the mounting surface of the circuit board and projecting toward a contact surface with the terminal fitting in the terminal contact portion.

13. The circuit board of claim 10, wherein:
the board-side terminal is formed with a curved surface portion along a displacement path of the terminal fitting swinging with a shaft portion as a fulcrum, and
a resilient contact piece of the terminal fitting slides in contact with the curved surface portion while being resiliently deformed.
